(19) United States
(12) Patent Application Publication
(10) Pub. No.: US 2017/0116641 A1
(43) Pub. Date: Apr. 27, 2017

(54) COMPUTING SYSTEM WITH DATA STRUCTURE FOR MAPPING ANSWERS TO KEYWORDS

(71) Applicant: Bloxi LLC, Eugene, OR (US)

(72) Inventors: Nathan Harry Bernstein, Eugene, OR (US); Thomas Harold Emmons, Eugene, OR (US); Shane Curtis Johnson, Springfield, OR (US)

(21) Appl. No.: 14/923,267

(22) Filed: Oct. 26, 2015

(51) Int. Cl. G06Q 30/02

(52) U.S. Cl. CPC G06Q 30/0256

(57) ABSTRACT

A computing system with a data structure for mapping answers to keywords, the computing system including a computer based quiz program executed on a processor of a client computing device, configured to cause the processor to: retrieve quiz data for a computer based quiz including one or more questions, display the computer based quiz via a display associated with the client computing device, receive a user input of an answer for each question of the computer based quiz, retrieve at least one keyword associated with one or more answers from a data structure that maps answers of the one or more questions of the computer based quiz to one or more associated keywords.

### BACKGROUND

In the field of online advertising, targeted advertisements that are selected based on a user's inferred interests may be more effective than non-targeted advertisements that are selected without regard to characteristics of the user, since users may be influenced by advertisements that relate to their interests more often than those that do not. Current targeted advertising methods include serving advertisements based on a history of websites visited by a user. Another current advertising method includes serving advertisements that are selected based upon keyword searches performed by a user at a search engine. Yet another current method includes serving advertisements that are selected based upon products browsed within an ecommerce website by a user. However, these methods suffer from the drawback that they are reactive to the user's website history, search history, and browsed products on existing websites, and a user's true interests may be difficult to accurately infer from these parameters. Thus, online advertisers are continually faced with a challenge of developing technology that can be used to more accurately infer each user's interests and more effectively select advertisements that are relevant to each user.

### SUMMARY

To address the issues discussed above, a computing system for computer based quiz targeted advertising is provided. The computing system may include a computer based quiz program executed on a processor of a client computing device, which is configured to cause the processor to: retrieve quiz data for a computer based quiz including one or more questions, display the computer based quiz via a display associated with the client computing device, receive a user input of an answer for each question of the computer based quiz, retrieve at least one keyword associated with one or more answers from a data structure that maps answers of the one or more questions of the computer based quiz to one or more associated keywords, send an advertisement request to an advertisement server, the advertisement request including the keyword, receive a targeted advertisement for the keyword from the advertisement server, and display the targeted advertisement to the user of the client computing device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of one embodiment of a computing system for computer based quiz targeted advertising.

FIG. 2 is a communications flow diagram showing communications between a client computing device, quiz server, and advertising server of the computing system of FIG. 1, the communications flow diagram illustrating one embodiment of a method for implementing computer based quiz targeted advertising.

FIG. 3 illustrates an example quiz with an example advertisement, served by the computing system of FIG. 1.

### DETAILED DESCRIPTION

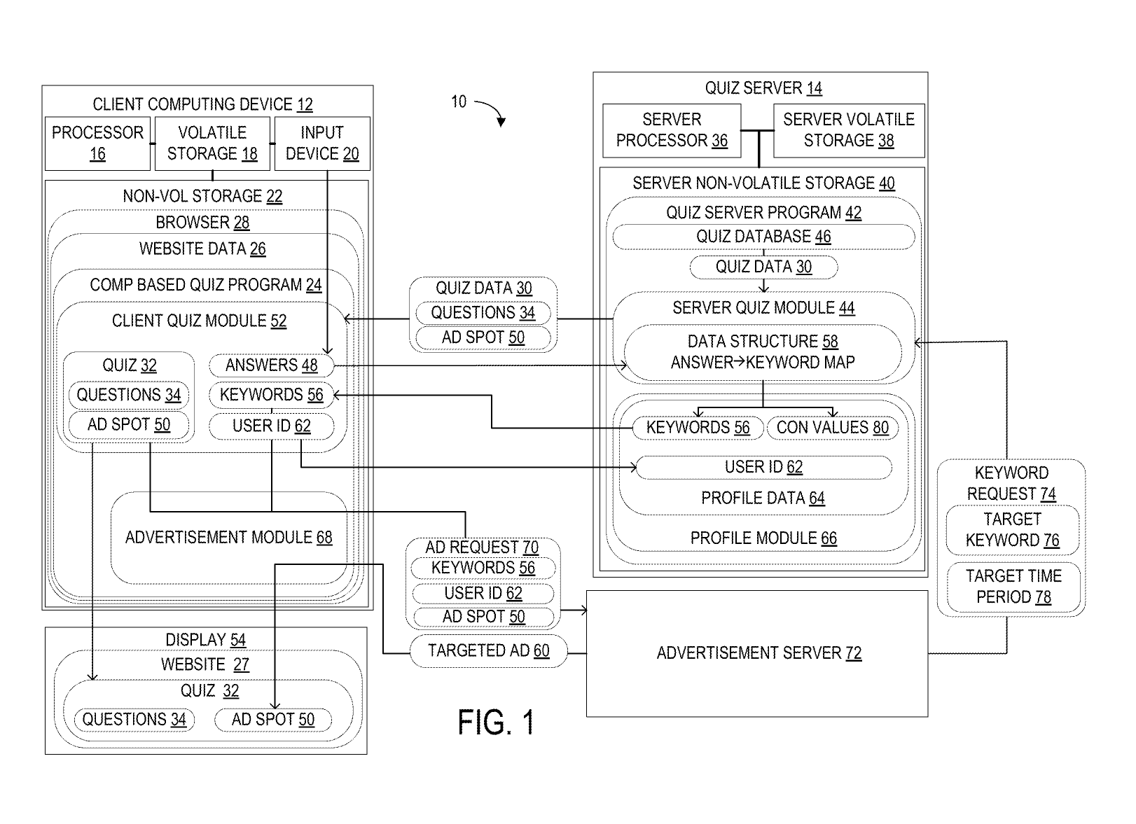

FIG. 1 illustrates a computing system 10 according to one embodiment of the present disclosure. As shown, computing system 10 includes a client computing device 12, which, for example, may take the form of a smartphone, a tablet computing device, or a desktop computing device, configured to communicate via a computer network with a quiz server 14. Client computing device 12 includes a processor 16, a volatile storage device 18 (such as RAM), an input device 20 (such as a touch screen, mouse, keyboard, trackpad, etc.), and non-volatile storage 22 (such as a hard drive or solid state memory). The computing system 10 comprises a computer based quiz program 24 executed on the processor 16 of the client computing device 12. The computer based quiz program 24 may take the form of a run-time executable program in a language such as JavaScript embedded in website data 26 of a third party website 27 being viewed by a user with a browser 28 and executed using the run time environment of the browser 28 executed by the client computing device 12. However, it will be appreciated that other forms of the computer based quiz program 24 are possible. For example, the computer based quiz program 24 may be a stand-alone (as opposed to embedded) application program run on the client computing device 12.

The computer based quiz program 24 is configured to cause the processor 16 to retrieve quiz data 30 for a computer based quiz 32 including one or more questions 34. In one embodiment, the quiz data 30 is retrieved from the quiz server 14 over the computer network, by sending a request to the quiz server 14 and receiving a reply containing the quiz. The quiz server 14 includes a server processor 36, a server volatile storage (such as RAM) 38, a server non-volatile storage 40 (such as a hard drive or solid state memory), and is configured to execute a quiz server program 42 using portions of volatile memory. The quiz server program 42 includes a server quiz module 44 that is configured to generate the computer based quiz 32 including one or more questions 34. Server quiz module 44 may generate the computer based quiz 32 by selecting and retrieving the quiz data 30 from a quiz database 46, which is a database of quiz questions organized into pre-made quizzes, or programmatically selected at request time for inclusion in a quiz.

Each computer based quiz stored in the quiz database 46 may include a quiz title, an introduction and/or explanation of the theme or content of the quiz, a category/topic of the quiz, one or more questions 34 and answers 48, a result or set of results of the quiz, and an advertisement spot 50 where advertisements may be displayed. The computer based quizzes may include a combination of text, images, video, audio, and metadata. The one or more questions 34 may take the form of any suitable question type including multiple choice, true/false, yes/no, matching, or hotspot (answer the question by clicking a spot on an image) as a few non-limiting examples.

Following generation of the quiz data at the quiz server 42, the quiz server program 42 is configured to send quiz data 30 for the computer based quiz 32 to the client computing device 12 for display to a user, in response to the request. The quiz data 30 is received at a client quiz module 52 of the computer based quiz program 24 executed by the processor 16 of the client computing device 12. The client quiz module 52 is configured to use the quiz data 30 to display the computer based quiz 32 via a display 54 associated with the client computing device 12, the displayed computer based quiz 32 including the one or more questions 34 and the advertisement spot 50.

In one specific example, the computer based quiz 32 is displayed in an iframe at a position in the third party website 27 that may be chosen by the owner of the third party website 27. However, it will be appreciated that the computer based quiz 32 may be embedded in the third part website 27 using any suitable embedding method. The one or more questions 34 and the advertisement spot 50 may be presented to the user of the client computing device 12 through several presentation methods. For example, the one or more questions 34 may be displayed as separate pages or layers that are consecutively paged through as the user inputs answers. In this example, the advertising spot 50 may be displayed as one of the pages or layers, or may be displayed alongside one or more of the questions 34. Alternatively, the one or more questions 34 and the advertising spot 50 may be presented as a single page that may be scrolled through by the user.

The user of the client computing device 12 may interact with the computer based quiz 32 via the input device 20. The input device 20 may be a keyboard and mouse, a touch screen, a microphone, or any other suitable input device. The client quiz module 52 of the computer based quiz program 24 is configured to receive a user input of an answer 48 for each question 34 of the computer based quiz 32. As the user progresses through the quiz, the answers chosen or given by the user for each question may be tracked as metadata by the client quiz module 52 and the server quiz module 44. The user's non-answer interactions with the quiz may also be tracked, such as how much time is spent on each question of the quiz. Each question and answer may also contain metadata that has been associated with them in the form of keywords 56. These keywords may represent behavioral characteristics, demographic information, or other characteristics of the user that may be derived from the user's answers 48 to the questions 34 of the computer based quiz 32.

After receiving the user input of answers to questions 34 of the computer based quiz 32, the client quiz module 52 is configured to retrieve at least one keyword 56 associated with one or more answers 48 from a data structure 58 that maps answers 48 of the one or more questions 34 of the computer based quiz 32 to one or more associated keywords 56. In one embodiment, to retrieve the keyword 56, the client quiz module 52 sends the answers 48 entered by the user to the server quiz module 44 of the quiz server 14. The server quiz module 44 is configured to receive the user input of the answer 48 for each question 34 of the computer based quiz 32. In this embodiment, the server quiz module 44 is configured to retrieve at least one keyword 56 associated with one or more answers 48 from a data structure 58 that maps answers 48 of the one or more questions 34 of the computer based quiz 32 to one or more associated keywords 56. The data structure 58 may be configured to map the possible answers for questions to specific metadata that can be derived about the user from the answers. In some embodiments, only a portion of the questions 34 of the computer based quiz 32 are used to elicit answers 48 from the user that are associated with keywords 56. For example, the computer based quiz 32 may include ten questions 34, and the user's answers for only two of those questions may be used to retrieve an associated keyword 56.

It will be appreciated that the questions and answers for each computer based quiz 32 retrieved from the quiz database 46 may be generated to derive specific behavioral characteristics or demographic data of the user. In one specific example, the answer to a question may be a picture of a dog that is selected by the user via the input device 20, and the data structure 58 may map that specific answer to the keyword “dog preference”. Thus, after receiving the user input of the answer 48 of a selection of the picture of a dog, the server quiz module 44 queries the data structure 58 with that answer, and retrieves the keyword “dog preference”.

After retrieving the at least one keyword 56, the quiz server program 42 is configured to send the keyword 56 to the client computing device 12 to cause the client computing device 12 to request and display a targeted advertisement 60 for the keyword 56. For example, if the keyword is “dog preference”, then a suitable targeted advertisement would be an advertisement for dog food.

The keyword 56 is received at the client quiz module 52 of the computer based quiz program 24. The client quiz module 52 is configured to retrieve user identification data 62 from the client computing device 12. It will be appreciated that the user identification data 62 may comprise a variety of data that may be used in combination or alone to uniquely identify the user of the client computer device 12. A few non-limiting examples of user identification data 62 are data indicating a user is currently logged into social media accounts, IP address, MAC address, browser 28's current version and add-ons, retrievable computer specifications, cookies, and local shared objects. The client quiz module 52 may be configured to send the user identification data 62 to the quiz server 14 to be associated with profile data 64 for the user stored in a profile module 66 of the quiz server program 42.

An advertisement module 68 of the computer based quiz module 24 is configured to send an advertisement request 70 to an advertisement server 72, the advertisement request 70 including the keyword 56. The advertisement request 70 may include additional data, such as the user identification data 62 and the advertisement spot 50 to facilitate targeting advertisements to the user of the client computing device 12 based on the keywords 56. In one embodiment, the additional data may further include data and/or metadata from the computer based quiz 32, such as text of the one or more questions 34, intro text for the computer based quiz 32, a category of the computer based quiz 32, time spent on each questions 34, or any other suitable metadata associated with the computer based quiz 32. Next, the advertisement module 68 is configured to receive a targeted advertisement 60 for the keyword 56 from the advertisement server 72, and display the targeted advertisement 60 to the user of the client computing device 12. The targeted advertisement 60 may be displayed in the advertisement spot 50 of the computer based quiz 32. However, it will be appreciated that the website 27 may include other locations for advertisements, such as a banner advertisement. Accordingly, the advertisement module 68 may be configured to refresh or update the other advertisements on the website 27 with the targeted advertisement 60.

The computer based quiz 32 may be either static or adaptive. One version of computer based quiz 32 includes a predetermined number of questions 34 that may be answered by the user. Alternatively, in an adaptive version of computer based quiz 32 contents of the one or more questions 34 of the computer based quiz 32 are configured to be modified while the user is interacting with the computer based quiz 32. For example, the computer based quiz 32 may be configured to include questions 34 that contain content that may be modified on the fly, or may be configured such that questions 34 may be added to or removed from the computer based quiz 32 concurrently with the user interacting with the computer based quiz 32. In one embodiment, the computer based quiz program 24 is further configured to cause the processor 16 to modify contents of a next question of the computer based quiz based on a user input of an answer to a previous question of the computer based quiz. In one specific example, if the user input of an answer to a previous question of the computer based quiz was a selection of a picture of a dog, then the computer based quiz program 24 may be configured to modify the contents of the next question of the computer based quiz that the user has not yet answered to be a question about various dog breeds or dog foods. Thus, once a specific category determination has been made about the user, such as dog owner, questions that aim to further identify a subcategory, may be presented, adaptively, within the quiz.

Additionally, the questions 34 of the computer based quiz 32 may be modified by the quiz server 14. The quiz server program 42 may be configured to receive a keyword request 74 from the advertisement server, the keyword request including a target keyword 76. The target keyword is a keyword that identifies a specific behavioral characteristic or demographic of users that are valuable to the advertisement server 72 for a targeted advertisement. More specifically, the target keyword 76 may be a keyword for which the advertisement server 72 has received bids from advertisers to display advertisements. In some embodiments, the target keyword 76 may be sent only for popular keywords, for which a bid price offered by advertisers has exceeded a predetermined threshold, for example.

Next, the server quiz module 44 of the quiz server program 42 is configured to retrieve a target question associated with the target keyword from the data structure. To retrieve the target question, the server quiz module 44 queries the data structure 44 with the target keyword to retrieve any questions that have an answer associated with the target keyword. For example, if the target keyword is “prefers dogs”, then a question may be retrieved that includes a plurality of pictures of different animals that may be selected as answers, one of which is an answer that is a picture of a dog, the pictures being displayable with the caption “Which Animal Are You Most Like?” After retrieving the target question, the server quiz module 44 is configured to modify the one or more questions of the computer based quiz to include the target question. In this way, the quiz server is able to modify the quiz served to a particular client computing device, based on keyword requests from the advertisement server, which in turn can help assure that sufficient advertisement impressions are generated for keywords that have bids above a certain threshold, for example.

The keyword request 74 sent by the advertisement server 72 may additionally include a target time period, which may be a specific time range during the day, day of week, date, month, year, or other specific time period. The advertisement server 72 send the keyword request because it has already received orders for advertisements targeted to the specified keywords for the requested time period, or because it anticipates, based on prior demand history, that such orders during the specified time period, for example. The server quiz module 44 may be further configured to receive a keyword request 74 from the advertisement server 72, the keyword request 74 including a target keyword 76 and a target time period 78, and determine whether a current time is within the target time period 74. That is, the server quiz module 44 determines whether the current time of day or the current portion of the year is within the target time period 78 specified in the keyword request 74. If a determination is made that the current time is within the target time period, the server quiz module 44 is configured to retrieve a target question associated with the target keyword from the data structure and modify the one or more questions of the computer based quiz to include the target question, in the same manner discussed above. By doing so, the quiz server is able to modify the quiz served to a particular client computing device, based not only on keyword requests from the advertisement server, but on keyword requests that are valid for a particular time period, which in turn can help increase the relevance of the advertisements to both the advertiser and end user. This technique can be used, for example, to increase the ad spots with the target keyword 76 during a sporting event at a certain time, on weekends, during a shopping period prior to a holiday, etc. Further, the target time period 78 may be a relative time period that is computed relative to a particular user as inferred or identified via the user's profile data 64. Thus, the target time period 78 may specify that the keywords be requested on a particular user's wedding anniversary, birthday, during a user's vacation, or within one hour of a user leaving a place of employment, for example.

In one embodiment, the quiz server 14 is configured to generate a profile for each user that contains known behavioral characteristics and demographic information of the user. In this embodiment, the keyword 56 is aggregated with a profile 64 of the user that contains other keywords associated with answers of the user to prior questions of one or more computer based quizzes, the profile further containing other user data including a user identification 62. Thus, each keyword associated with answers inputted by the user may be collected and aggregated into the profile 64 stored in a profile module 66 of the quiz server program 42. Typically, the building of the profile is subject to the user's opt-in approval. The profile 64, it will be appreciated, over time may come to include keywords that indicate or suggest user's nationality, languages spoken, race, gender, age, place of employment, residence location, income level, hobbies, calendar, asset ownership (such as house, car, etc.), interests, preferences (e.g. favorite color), or any other suitable characteristic of the user.

Further in this embodiment, the data structure 58 includes an associated confidence value 80 for each keyword 56 associated with an answer 48, and the associated confidence value 80 is aggregated in the profile 64 of the user for each keyword 56 aggregated with the profile 64 of the user. The confidence value of a keyword quantizes a strength of the association between the keyword and its associated answer. For example, if a question is “Which car do you prefer”, and the user's answer is “Pickup Truck”, that answer may be associated with the keyword “prefers dogs” from a known correlation between pickup truck drivers and dog owners. However, the strength of the above association may be relatively weak, thus the confidence value associated with that keyword for that answer may be low.

It will be appreciated that a particular keyword may be associated with the answers of different questions. For example, there may be multiple answers to questions from which the behavior characteristic of “prefers dogs” may be derived. Additionally, if the user's answers over multiple questions and quizzes are frequently associated with the keyword “prefers dogs”, then it is more likely that the user actually has a preference for dogs. Accordingly, in one embodiment, the associated confidence value 80 for each keyword 56 associated with the profile 64 of the user is aggregated as an aggregated confidence value, the aggregated confidence value for each keyword 56 being updated each time that keyword 56 is associated with a user input of an answer 48 to a question 34 of a computer based quiz 32. It will be appreciated that the confidence values may be aggregated into an aggregated confidence value with a variety of methods. In one specific example, the associated confidence values for each keyword are summed into a total confidence value as the aggregated confidence value. Thus, if the pickup question above resulted in a “prefers dogs” keyword with a 1 point confidence value, and a second question was answered that had an associated confidence value of 3 points, the aggregate confidence rating may be expressed as 4 points. However, it will be appreciated that other suitable aggregating formulas may be used to aggregate the associated confidence values for a keyword. For example, the confidence values may be expressed as probabilities, such as 0.1 and 0.3, and may be aggregated using statistical formula, such as (1−0.1)(1−0.3)=1−aggregated confidence value, therefore aggregated confidence value=0.37.

In this embodiment, the quiz server program 42 is further configured to determine whether the aggregated confidence value of the keyword 56 is greater than a threshold value. The threshold value may be chosen depending on the aggregating formula used to aggregate the confidence values, and represents a suitable probability that the keyword accurately represents the user. If a determination is made that the aggregated confidence value of the keyword 56 is greater than the threshold value, the quiz server program 42 is further configured to cause the client computing device 12 to send the advertisement request 70 to the advertisement server 72, the advertisement request including the keyword 56, in the same manner discussed above. Thus, the aggregated confidence value of 0.37 computed as described above may be found to be above a predetermined threshold value of, for example, 0.3. Since the confidence value is above the threshold, the quiz server program 42 causes the client computing device to send advertisement request 70 to request an advertisement associated with the target keyword. This is accomplished by quiz server program inserting into quiz data 30 a question 34 having as one possible answer an answer associated with the target keyword 76, as determined by the answer keyword map in data structure 58. In this way, when the question is presented to the user in the quiz 34 via client quiz module 52, if the user selects the same answer that has been associated with the target keyword, the advertisement module 68 will send ad request 70 with a keyword 56 that is the same as target keyword 76. As a result, a targeted ad 60 will be sent from the advertisement server 72 to the client computing device for display in ad spot 50 of quiz 32 on display 54.

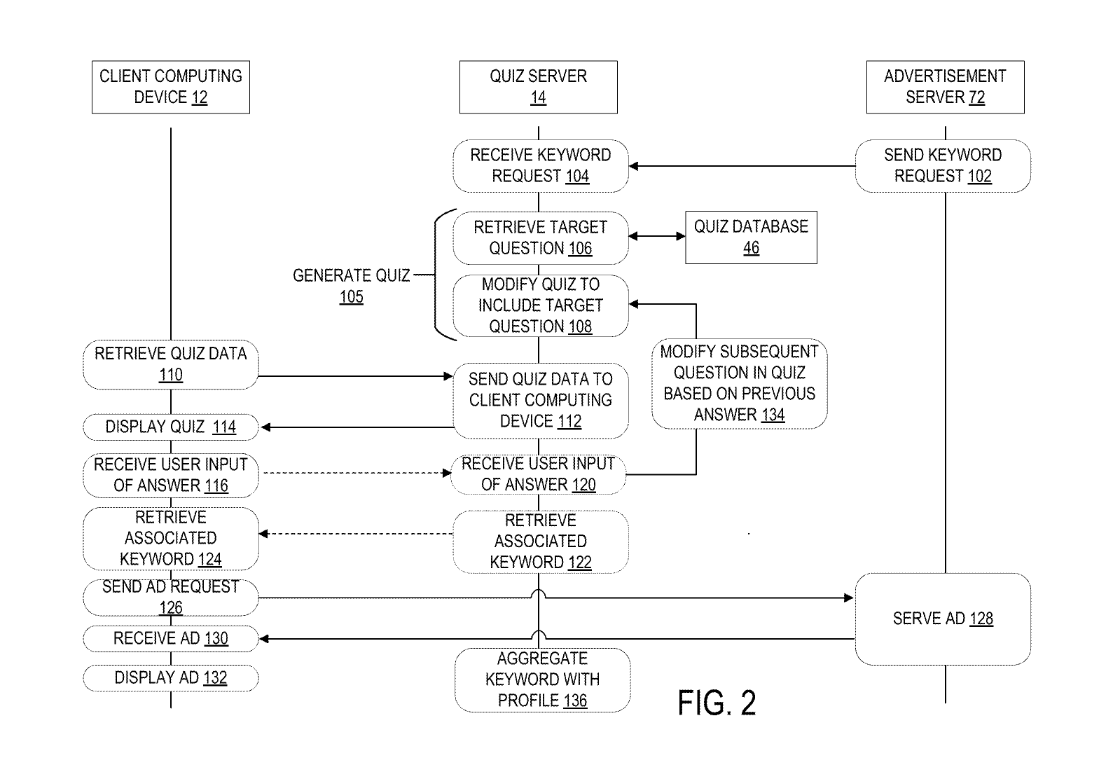

Turning now to FIG. 2, one embodiment of a method 100 for implementing computer based quiz targeted advertising is shown. Method 100 may be implemented using the system 10 described above, or via other suitable hardware. Thus, FIG. 2 illustrates method 100 in a communications flow diagram showing communications between a client computing device 12, quiz server 14, and advertisement server 72 of the computing system 10 of FIG. 1.

As shown, method 100 may include, at 102, sending a keyword request from an advertisement server to a quiz server. At 104, the method may include receiving, at the quiz server, a keyword request from the advertisement server, the keyword request including a target keyword. At 105, the method may include, at the server, generating a computer based quiz including one or more questions. This may be accomplished, as shown at 106, by retrieving a target question associated with the target keyword from the data structure, and as shown at 108, modifying the one or more questions of the computer based quiz to include the target question. Typically, the target question is retrieved from a quiz database 46 associated with the quiz server 14.

At 110, the method may include retrieving quiz data for a computer based quiz including one or more questions.

At 114, the method may include displaying the computer based quiz to a user via a display associated with a client computing device. At 116, the method may include, receiving a user input of an answer for each question of the computer based quiz. At 118, the method may include, retrieving at least one keyword associated with one or more answers from a data structure that maps answers of the one or more questions of the computer based quiz to one or more associated keywords. To retrieve the keyword, the client computing device sends the answer entered by the user to the quiz server, as shown by the line connecting 116 and 120. At 120, the method includes the quiz server receiving the user input of the answer for each question of the computer based quiz. At 122, the method includes the quiz server retrieving at least one keyword associated with one or more answers from a data structure that maps answers of the one or more questions of the computer based quiz to one or more associated keywords. The server then sends the keyword back to the client computing device, for inclusion in the ad request sent at 124, as shown by the dashed line connecting 122 and 124.

At 126, the method may include sending an advertisement request to the advertisement server, the advertisement request including the keyword. At 128, the method may include, at the target server, in response to receiving the ad request with a keyword sent from the client computing device, serving a targeted advertisement for the keyword.

At 130, the method may include receiving the targeted advertisement for the keyword from the advertisement server. At 132, the method may include displaying the targeted advertisement to the user on a display associated with the client computing device.

In some implementations, the contents of one or more questions of the computer based quiz are configured to be modified while the user is interacting with the computer based quiz. Thus, as shown at 134, the method may include modifying contents of a subsequent question of the computer based quiz based on a user input of an answer to a previous question of the computer based quiz.

In some implementations, the keyword request sent at 102 may include a target time period. Thus, at 104, when the method receives a keyword request from the advertisement server, the keyword request may including both the target keyword and a target time period. Accordingly, when generating the quiz at 105, the quiz server may determine whether a current time is within the target time period, and if a determination is made that the current time is within the target time period, the quiz server may retrieve a target question associated with the target keyword from the data structure and modify the one or more questions of the computer based quiz to include the target question, at 106 and 108 respectively.

At 136, the method may further include aggregating the keyword with a profile of the user that contains other keywords associated with answers of the user to prior questions of one or more computer based quizzes. It will be appreciated that the profile may further contain other user data including a user identification.

Like system 10 above, in method 100, the data structure may include an associated confidence value for each keyword associated with an answer, and the associated confidence value may be aggregated in the profile of the user for each keyword aggregated with the profile of the user. Further, the associated confidence value for each keyword associated with the profile of the user may be aggregated as an aggregated confidence value, the aggregated confidence value for each keyword being updated each time that keyword is associated with a user input of an answer to a question of a computer based quiz. Further, sending an advertisement request to an advertisement server, may further include: determining whether the aggregated confidence value of the keyword is greater than a threshold value, and if a determination is made that the aggregated confidence value of the keyword is greater than the threshold value, sending the advertisement request to the advertisement server, the advertisement request including the keyword.

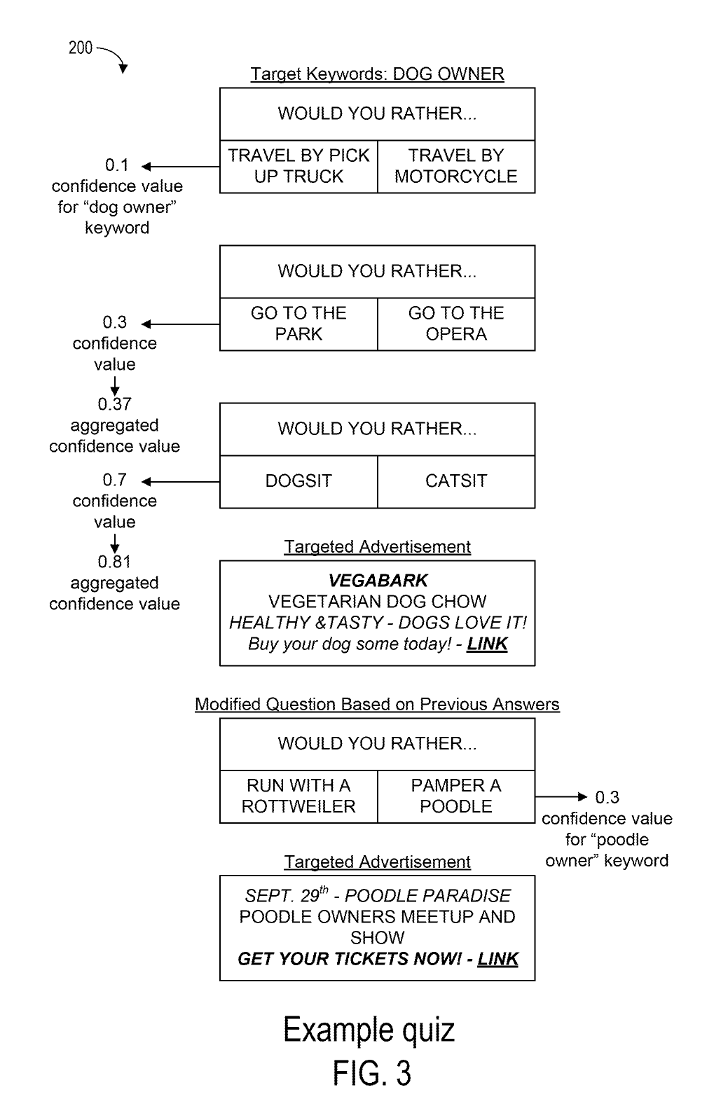

Turning now to FIG. 3, an example quiz 200 served by quiz server 14 will now be described. Example quiz 200 is generated after quiz server 14 has received target keywords DOG OWNER from advertising server 72. In response, the quiz server has generated quiz 200 by selecting several questions with answers that are associated with the keywords DOG OWNER, by a confidence value. In the first question, an answer that the user would rather TRAVEL BY PICK UP than TRAVEL BY MOTORCYCLE gives a confidence value of 0.1 that the user is a dog owner. Likewise, answering that the user would rather GO TO THE PARK than GO TO THE MOVIES gives another confidence value of 0.3, which is aggregated with the previous value according to the aggregation formula discussed above, to provide an aggregated confidence value of 0.37. In the third question, a response that the user would rather DOGSIT than CATSIT is associated with a 0.7 confidence value for DOG OWNER, which is in turn aggregated with the other scores for a 0.81 aggregated confidence value that the user is a dog owner. This is above a threshold for serving DOG OWNER related ads, and therefore, the client computing device is caused to send a request for an advertisement with the keywords DOG OWNER to the advertisement server. In the illustrated example, an advertisement for VEGABARK vegetarian dog food is received from the advertisement server and displayed at the client computing device.

The fourth question in the quiz was modified based on the previous answers. The quiz server determined that the confidence for DOG OWNER was above a predetermined threshold, and determined that a question could be presented that tried to determine the breed of dog owned by the user. Accordingly, a question was selected by the quiz server related to dog breeds. By answering that the user would rather PAMPER A POODLE than RUN WITH A ROTTWEILER, a 0.3 confidence value for POODLE OWNER is assigned to the user. In response, a second in-quiz advertisement is requested with the keywords POODLE OWNER, and a targeted advertisement related to a POODLE PARADISE dog show is downloaded and displayed. Both the 0.3 confidence value for POODLE OWNER and the 0.81 aggregated confidence value for DOG OWNER are stored in the user profile for the user for future reference.

Using the above described systems and methods, a quiz can be presented to a user, which is not only entertaining but also can be used to build a profile of the user that includes associated keywords and confidence values, based on the answers to the quiz. Those keywords can be sent with advertisement requests to an advertisement server in order to download and display targeted advertisements related to the keywords. In this manner, users can view advertisements that are more relevant to their interests, and advertisers can more effectively target their advertisements to users. This, in combination with the modification of quiz questions based on prior answers, and the generation of the quiz based on target keywords received from advertisers, and the various other features described herein, offers the potential advantage of increased effectiveness for online advertising.

It will be appreciated that the computing devices of the computing system illustrated in FIG. 1 and described herein may take the form of one or more personal computers, server computers, tablet computers, home-entertainment computers, network computing devices, gaming devices, mobile computing devices, mobile communication devices (e.g., smart phone), and/or other computing devices.

Each such computing device includes a processor, volatile memory, and non-volatile memory, as well as a display, input device, and communication system configured to enable the computing device to communicate with other devices via a computer network.

The processor of each computing device is configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The processor of each device is typically configured to execute software instructions that are stored in non-volatile memory using portions of volatile memory. Additionally or alternatively, the processor may include one or more hardware or firmware processors configured to execute hardware or firmware instructions. Processors used by the devices described herein may be single-core or multi-core, and the instructions executed thereon may be configured for sequential, parallel, and/or distributed processing. Individual components of the processor optionally may be distributed among two or more separate devices, which may be remotely located and/or configured for coordinated processing. Aspects of the processor may be virtualized and executed by remotely accessible, networked computing devices configured in a cloud-computing configuration.

Non-volatile memory is configured to hold software instructions even when power is cut to the device, and may include optical memory (e.g., CD, DVD, HD-DVD, Blu-Ray Disc, etc.), solid state memory (e.g., EPROM, EEPROM, FLASH memory, etc.), and/or magnetic memory (e.g., hard-disk drive, floppy-disk drive, tape drive, MRAM, etc.), among others. Volatile memory is configured to hold software instructions and data temporarily during execution of programs by the processor, and typically such data is lost when power is cut to the device. Examples of volatile memory that may be used include RAM, DRAM, etc.

Aspects of processor, non-volatile memory, and volatile memory may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 10 implemented to perform a particular function. In some cases, a module, program, or engine may be instantiated via a processor executing instructions stored in non-volatile memory using portions of volatile memory at execution time. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

Each computing device may include an associated display, which may be used to present a visual representation of data computed and output by the processor. This visual representation may take the form of a graphical user interface (GUI). Such display devices may be combined with processor, volatile memory, and non-volatile memory in a shared enclosure, or such display devices may be peripheral display devices. Touch screens may be utilized that function both as a display and as an input device.

Each computing device may include a user input device such as a keyboard, mouse, touch pad, touch screen, microphone or game controller.

Each computing device may include a communication subsystem configured to communicatively couple the computing device with one or more other computing devices. The communication subsystem may include wired and/or wireless communication devices compatible with one or more different communication protocols. As non-limiting examples, the communication subsystem may be configured for communication via a wireless telephone or data network, or a wired or wireless local- or wide-area network. In some embodiments, the communication subsystem may allow the computing device to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing system, comprising:
a computer based quiz program executed on a processor of a client computing device and configured to cause the processor to:
retrieve quiz data for a computer based quiz including one or more questions;
display the computer based quiz via a display associated with the client computing device;
receive a user input of an answer for each question of the computer based quiz;
retrieve at least one keyword associated with one or more answers from a data structure that maps answers of the one or more questions of the computer based quiz to one or more associated keywords;
send an advertisement request to an advertisement server, the advertisement request including the keyword;
receive a targeted advertisement for the keyword from the advertisement server; and
display the targeted advertisement to the user of the client computing device.

2. The computing system of claim 1, wherein contents of the one or more questions of the computer based quiz are configured to be modified while the user is interacting with the computer based quiz.

3. The computing system of claim 2, wherein the computer based quiz program is further configured to cause the processor to:
modify contents of a next question of the computer based quiz based on a user input of an answer to a previous question of the computer based quiz.

4. The computing system of claim 2, further comprising:
a quiz server including a quiz server processor configured to:
receive a keyword request from the advertisement server, the keyword request including a target keyword;
retrieve a target question associated with the target keyword from the data structure; and
modify the one or more questions of the computer based quiz to include the target question.

5. The computing device of claim 2, further comprising:
a quiz server including a quiz server processor configured to:
receive a keyword request from the advertisement server, the keyword request including a target keyword and a target time period;
determine whether a current time is within the target time period;
if a determination is made that the current time is within the target time period, retrieve a target question associated with the target keyword from the data structure and modify the one or more questions of the computer based quiz to include the target question.

6. The computing system of claim 1, wherein the keyword is aggregated with a profile of the user that contains other keywords associated with answers of the user to prior questions of one or more computer based quizzes, the profile further containing other user data including a user identification.

7. The computing system of claim 6, wherein the data structure includes an associated confidence value for each keyword associated with an answer, and the associated confidence value is aggregated in the profile of the user for each keyword aggregated with the profile of the user.

8. The computing system of claim 7, wherein the associated confidence value for each keyword associated with the profile of the user is aggregated as an aggregated confidence value, the aggregated confidence value for each keyword being updated each time that keyword is associated with a user input of an answer to a question of a computer based quiz.

9. The computing system of claim 8, wherein to send an advertisement request to an advertisement server, the computer based quiz program is further configured to cause the processor to:
determine whether the aggregated confidence value of the keyword is greater than a threshold value;
if a determination is made that the aggregated confidence value of the keyword is greater than the threshold value, send the advertisement request to the advertisement server, the advertisement request including the keyword.

10. A method comprising:
retrieving quiz data for a computer based quiz including one or more questions;
displaying the computer based quiz to a user via a display associated with a client computing device;
receiving a user input of an answer for each question of the computer based quiz;
retrieving at least one keyword associated with one or more answers from a data structure that maps answers of the one or more questions of the computer based quiz to one or more associated keywords;
sending an advertisement request to an advertisement server, the advertisement request including the keyword;
receiving a targeted advertisement for the keyword from the advertisement server; and
displaying the targeted advertisement to the user of the client computing device.

11. The method of claim 10, wherein contents of the one or more questions of the computer based quiz are configured to be modified while the user is interacting with the computer based quiz.

12. The method of claim 11, further comprising:
modifying contents of a next question of the computer based quiz based on a user input of an answer to a previous question of the computer based quiz.

13. The method of claim 11, further comprising:
receiving a keyword request from the advertisement server, the keyword request including a target keyword;
retrieving a target question associated with the target keyword from the data structure; and
modifying the one or more questions of the computer based quiz to include the target question.

14. The method of claim 11, further comprising:
receiving a keyword request from the advertisement server, the keyword request including a target keyword and a target time period;
determining whether a current time is within the target time period;
if a determination is made that the current time is within the target time period, retrieving a target question associated with the target keyword from the data structure and modify the one or more questions of the computer based quiz to include the target question.

15. The method of claim 10, wherein the keyword is aggregated with a profile of the user that contains other keywords associated with answers of the user to prior questions of one or more computer based quizzes, the profile further containing other user data including a user identification.

16. The method of claim 15, wherein the data structure includes an associated confidence value for each keyword associated with an answer, and the associated confidence value is aggregated in the profile of the user for each keyword aggregated with the profile of the user.

17. The method of claim 16, wherein the associated confidence value for each keyword associated with the profile of the user is aggregated as an aggregated confidence value, the aggregated confidence value for each keyword being updated each time that keyword is associated with a user input of an answer to a question of a computer based quiz.

18. The method of claim 17, wherein sending an advertisement request to an advertisement server, further comprises:
determining whether the aggregated confidence value of the keyword is greater than a threshold value;
if a determination is made that the aggregated confidence value of the keyword is greater than the threshold value, sending the advertisement request to the advertisement server, the advertisement request including the keyword.

19. A computing system, comprising:
a quiz server including a processor configured to:
generate a computer based quiz including one or more questions;
send quiz data for the computer based quiz to a client computing device for display to a user;
receive a user input of an answer for each question of the computer based quiz;
retrieve at least one keyword associated with one or more answers from a data structure that maps answers of the one or more questions of the computer based quiz to one or more associated keywords; and
send the keyword to the client computing device to cause the client computing device to request and display a targeted advertisement for the keyword.

20. The computing system of claim 19, wherein the processor of the quiz server is further configured to:
receive a keyword request from an advertisement server, the keyword request including a target keyword and a target time period;
determine whether a current time is within the target time period; and
if a determination is made that the current time is within the target time period, retrieve a target question associated with the target keyword from the data structure, and send the target question to the client computing device to be included in the computer based quiz.
